(19) United States
(12) Patent Application Publication
(10) Pub. No.: US 2026/0152690 A1
(43) Pub. Date: Jun. 4, 2026

(54) COLORLESS, PARTICLE-FREE, AMINOSILANE-CONTAINING WET ETCH FORMULATIONS

(71) Applicant: ENTEGRIS, INC., Billerica, MA (US)

(72) Inventors: Claudia Yevenes, White Plains, NY (US); Daniela White, Ridgefield, CT (US); Rebecca Pannaman, Fairfield, CT (US)

(21) Appl. No.: 19/408,057

(22) Filed: Dec. 3, 2025

Related U.S. Application Data
(60) Provisional application No. 63/727,642, filed on Dec. 3, 2024.

(51) Int. Cl. C09K 13/06

(52) U.S. Cl. CPC C09K 13/06

(57) ABSTRACT

Colorless etchant compositions and method of obtaining colorless etchant compositions are provided. Etchant compositions may comprise a phosphoric acid, an amine-containing compound, and a light absorbing compound. The light absorbing compound is a reaction product of the phosphoric acid and a decolorizing agent. The decolorizing agent may comprise a lanthanide compound in its highest oxidation state and have strong scavenging properties of reactive oxygen species or organic radicals formed during thermally or photochemically induced amine oxidation.

### CROSS-REFERENCE TO RELATED APPLICATIONS

This application claims the benefit under 35 USC 119 of U.S. Provisional Patent Application No. 63/727,642, filed Dec. 3, 2024, the disclosure of which is hereby incorporated herein by reference in its entirety.

### FIELD

The present disclosure relates to colorless, particle-free, wet etch formulations containing aminosilanes.

### BACKGROUND

Amine-containing compounds can be oxidized thermally or photochemically during storage and use causing the compositions containing the compounds to become colored.

### SUMMARY

Some embodiments relate to an etchant composition. In some embodiments, the etchant composition comprises an amine-containing compound, a phosphoric acid compound, and a light absorbing compound. In some embodiments, the light absorbing compound comprises a reaction product of the phosphoric acid compound and a decolorizing agent. In some embodiments, the decolorizing agent comprises a lanthanide compound in its highest oxidation state. In some embodiments, the lanthanide compound has scavenging properties of reactive oxygen species or organic radicals formed during thermally or photochemically induce amine oxidation. In some embodiments, an APHA color value of the etchant composition is less than an APHA color value of a control etchant composition where the control etchant composition is same as the etchant composition but does not contain a light absorbing compound.

Some embodiments related to a method. In some embodiments, the method comprises obtaining an etchant composition. In some embodiments, the etchant composition comprises an amine-containing compound and a phosphoric acid compound. In some embodiments, the method comprises adding a decolorizing agent to the etchant composition. In some embodiments, the decolorizing agent comprises a lanthanide compound in its highest oxidation state. In some embodiments, the lanthanide compound has scavenging properties of reactive oxygen species or organic radicals formed during thermally or photochemically induce amine oxidation. In some embodiments, the method produces a colorless composition. In some embodiments, an APHA color value of the etchant composition is less than an APHA color value of a control etchant composition where the control etchant composition is same as the etchant composition but does not contain a light absorbing compound.

Some embodiments relate to a method. In some embodiments, the method comprises obtaining a colored composition. In some embodiments, the colored composition comprises a phosphoric compound, an amine-containing compound, and oxidation by-products of the amine-containing compound. In some embodiments, the method comprises adding a decolorizing agent to the colored composition. In some embodiments, the decolorizing agent comprises a lanthanide compound in its highest oxidation state. In some embodiments, the lanthanide compound has scavenging properties of reactive oxygen species or organic radicals formed during thermally or photochemically induce amine oxidation. In some embodiments, the method comprises producing a colorless composition.

Some embodiments relate to an etchant composition. In some embodiments, the etchant composition comprises a phosphoric acid compound, an amine-containing compound and a light absorbing compound. In some embodiments, the light absorbing compound comprises a reaction product of the phosphoric acid compound and a decolorizing agent. In some embodiments, the decolorizing agent comprises a lanthanide compound in its highest oxidation state. In some embodiments, the lanthanide compound has scavenging properties of reactive oxygen species or organic radicals formed during thermally or photochemically induce amine oxidation. In some embodiments, the etchant composition comprises less oxidation by-products of the amine-containing compound than a control etchant composition where the control etchant composition is same as the etchant composition but does not contain a light absorbing compound.

### BRIEF DESCRIPTION OF THE FIGURES

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a flowchart of a method for producing a colorless etchant composition, according to some embodiments.

FIG. 2 is a flowchart of a method for producing a colorless composition, according to some embodiments.

FIG. 3 is a flowchart of a method for selective etching of silicon nitride, according to some embodiments.

FIG. 4 is an overlay of UV-VIS spectra of Control 1 (colored, aged at 160° C.) vs. Control 1+0.1% Ce⁴⁺ cations (colorless, aged at 160° C.).

FIG. 5 is an overlay of LC-UV-QTOF chromatograms for Control 1 aged at 160° C., with and without 0.1% Ce⁴⁺ cations.

FIG. 6 is a graph showing color reduction, as decrease in APHA numbers for Control 1+Ce⁴⁺, fresh and aged formulations, vs. the increase in % of Ce⁴⁺ cations.

FIG. 7 is a turbidity graph, showing decrease in NTU numbers (turbidity) of an aged (at 160° C.), colored Control 1 sample, by added 0.1% Ce⁴⁺ and 0.1% La³⁺ cations, respectively.

### DETAILED DESCRIPTION

Some embodiments relate to an etchant composition. In some embodiments, the etchant composition is used in wet etching processes. In some embodiments, the etchant composition comprises an aqueous solution. In some embodiments, the etchant composition is particle-free.

In some embodiments, the etchant composition comprises an amine-containing compound.

In some embodiments, the amine-containing compound comprises a primary amine, a secondary amine, a tertiary amine, or a quaternary amine. In some embodiments, the amine-containing compound comprises an alkyl amine, a dialkylamine, or a trialkyl amine. In some embodiments, amine-containing compound comprises at least one of methyl amine, dimethylamine, ethylamine, diethylamine, isopropylamine, di-isopropylamine, butylamine, sec-butylamine, tert-butylamine, di-sec-butylamine, isobutylamine, diisobutylamine, di-tert-pentylamine, ethylmethylamine, isopropyl-n-propylamine, or any combination thereof. Examples of the alkylamines may include, without limitation, one or more of the following: primary alkylamines, such as, for example and without limitation, methylamine, ethylamine, n-propylamine, isopropylamine, n-butylamine, sec-butylamine, isobutylamine, t-butylamine, pentylamine, 2-aminopentane, 3-aminopentane, 1-amino-2-methylbutane, 2-amino-2-methylbutane, 3-amino-2-methylbutane, 4-amino-2-methylbutane, hexylamine, 5-amino-2-methylpentane, heptylamine, octylamine, nonylamine, decylamine, undecylamine, dodecylamine, tridecylamine, tetradecylamine, pentadecylamine, hexadecylamine, heptadecylamine, and octadecylamine; secondary alkylamines, such as, for example and without limitation, dimethylamine, diethylamine, dipropylamine, diisopropylamine, dibutylamine, diisobutylamine, di-sec-butylamine, di-t-butylamine, dipentylamine, dihexylamine, diheptylamine, dioctylamine, dinonylamine, didecylamine, methylethylamine, methylpropylamine, methylisopropylamine, methylbutylamine, methylisobutylamine, methyl-sec-butylamine, methyl-t-butylamine, methylamylamine, methylisoamylamine, ethylpropylamine, ethylisopropylamine, ethylbutylamine, ethylisobutylamine, ethyl-sec-butylamine, ethylamine, ethylisoamylamine, propylbutylamine, and propylisobutylamine; and tertiary alkylamines, such as, for example and without limitation, trimethylamine, triethylamine, tripropylamine, tributylamine, tripentylamine, dimethylethylamine, methyldiethylamine, and methyldipropylamine. Examples of polyamines may include, without limitation, one or more of the following: ethylenediamine, propylenediamine, trimethylenediamine, tetramethylenediamine, 1,3-diaminobutane, 2,3-diaminobutane, pentamethylenediamine, 2,4-diaminopentane, hexamethylenediamine, heptamethylenediamine, octamethylenediamine, nonamethylenediamine, N-methylethylenediamine, N,N-dimethylethylenediamine, trimethylethylenediamine, N-ethylethylenediamine, N, N-diethylethylenediamine, triethylethylenediamine, 1,2,3-triaminopropane, hydrazine, tris(2-aminoethyl)amine, tetra(aminomethyl) methane, diethylenetriamine, triethylenetetramine, tetraethylpentamine, heptaethyleneoctamine, nonaethylenedecamine, and diazabicyloundecene.

In some embodiments, the amine-containing compound comprises an aminosilane. In some embodiments, the aminosilane comprises primary aminosilanes, secondary aminosilanes, tertiary aminosilanes, quaternary aminosilanes, or multi-podal (e.g., dipodal) aminosilanes. In some embodiments, the aminosilane comprises a 3-aminopropylmethyl diethoxysilane, a N-(3-triethoxysilylpropyl)-4,5-dihydroimidazole, a N-(6-aminohexyl) aminomethyl triethoxysilane, a N-(2-aminoethyl)-3-aminoisobutylmethyl dimethoxysilane, a N-(2-aminoethyl)-3-aminopropylmethyl dimethoxysilane, a (N,N-diethylaminomethyl) triethoxysilane, a N-methylaminopropyl trimethoxysilane, an aminoethylaminopropylsilsesquioxane, or any combination thereof.

In some embodiments, the etchant composition comprises a phosphoric acid compound. In some embodiments, the phosphoric acid is provided in an aqueous phosphoric acid solution. In some embodiments, the aqueous phosphoric acid solution comprises 50% to 99% by weight of phosphoric acid based on a total weight of the aqueous phosphoric acid solution, or any range or subrange therebetween. In some embodiments, the aqueous phosphoric acid solution comprises 80% to 90% by weight of phosphoric acid based on a total weight of the aqueous phosphoric acid solution. In some embodiments, the aqueous phosphoric acid solution comprises 80% to 85% by weight of phosphoric acid based on a total weight of the aqueous phosphoric acid solution.

In some embodiments, the etchant composition comprises a light absorbing compound. In some embodiments, the light absorbing compound comprises a reaction product of the phosphoric acid compound and a decolorizing agent.

In some embodiments, the decolorizing agent comprises a lanthanide compound in its highest oxidation state. In some embodiments, the lanthanide compound comprises a lanthanide metal cation in its highest oxidation state or a lanthanide metal oxide in its highest oxidation state. In some embodiments, the lanthanide compound has strong scavenging properties of reactive oxygen species or organic radicals formed during thermally or photochemically induced amine oxidation.

In some embodiments, the lanthanide compound comprises a lanthanide metal cation or a lanthanide metal oxide in its highest oxidation state. In some embodiments, the lanthanide compound comprises a cerium compound, a praseodymium compound, a neodymium compound, a terbium compound, a dysprosium compound, a lanthanum compound, an europium compound, or any combination thereof. In some embodiments, the lanthanide compound comprises a salt or oxide of cerium (IV), europium (III), lanthanum (III), or any combination thereof.

In some embodiments, the turbidity of the etchant composition is less than a control etchant composition where the control etchant composition is same as the etchant composition but does not comprise a light absorbing compound, a decolorizing agent, or a combination thereof. In some embodiments, the turbidity of the etchant composition is 1 Nephelometric Turbidity Unit (NTU) or less. In some embodiments, the turbidity of the etchant composition is 0.9 NTU or less, 0.8 NTU or less, 0.7 NTU or less, 0.6 NTU or less, 0.5 NTU or less, 0.4 NTU or less, 0.3 NTU or less, 0.2 NTU or less, or 0.1 NTU or less. In some embodiments, the turbidity of the etchant composition is 0 to 1 NTU, or any range or subrange between 0 to 1 NTU. In some embodiments, the turbidity of the etchant composition is 0 to 0.9 NTU, 0 to 0.8 NTU, 0 to 0.7 NTU, 0 to 0.6 NTU, 0 to 0.5 NTU, 0 to 0.4 NTU, 0 to 0.3 NTU, 0 to 0.2 NTU, 0 to 0.1 NTU, 0.1 to 1 NTU, 0.2 to 1 NTU, 0.3 to 1 NTU, 0.4 to 1 NTU, 0.5 to 1 NTU, 0.6 to 1 NTU, 0.7 to 1 NTU, 0.8 to 1 NTU, or 0.9 to 1 NTU.

In some embodiments, the etchant composition is colorless as determined by having an APHA color of 100 or less. In some embodiments, the etchant composition has an APHA color of 100 or less. In some embodiments, the etchant composition has an APHA color of 90 or less, 80 or less, 70 or less, 60 or less, 50 or less, 40 or less, 30 or less, 20 or less, 10 or less, 5 or less, or 1 or less. In some embodiments, the etchant composition has an APHA color of 0 to 100, or any range or subrange between 0 to 100. In some embodiments, the etchant composition has an APHA color of 0 to 90, 0 to 80, 0 to 70, 0 to 60, 0 to 50, 0 to 40, 0 to 30, 0 to 20, 0 to 10, 0 to 5, 0 to 1, 1 to 100, 5 to 100, 10 to 100, 20 to 100, 30 to 100, 40 to 100, 50 to 100, 60 to 100, 70 to 100, 80 to 100, or 90 to 100.

In some embodiments, after aging at 160° C., the etchant composition remains colorless. In some embodiments, after aging at 160° C., the etchant composition continues to have an APHA color of 100 or less. In some embodiments, after aging at 160° C., the etchant composition continues to have an APHA color of 90 or less, 80 or less, 70 or less, 60 or less, 50 or less, 40 or less, 30 or less, 20 or less, 10 or less, 5 or less, or 1 or less. In some embodiments, after aging at 160° C., the etchant composition continues to have an APHA color of 0 to 100, or any range or subrange between 0 to 100. In some embodiments, after aging at 160° C., the etchant composition continues to have an APHA color of 0 to 90, 0 to 80, 0 to 70, 0 to 60, 0 to 50, 0 to 40, 0 to 30, 0 to 20, 0 to 10, 0 to 5, 0 to 1, 1 to 100, 5 to 100, 10 to 100, 20 to 100, 30 to 100, 40 to 100, 50 to 100, 60 to 100, 70 to 100, 80 to 100, or 90 to 100.

In some embodiments, the aging occurs at 160° C. for up to 30 days. In some embodiments, the aging occurs at 160° C. for 5 days to 30 days, or any range or subrange between 5 days to 30 days. In some embodiments, the aging occurs at 160° C. for 5 days to 25 days, 5 days to 20 days, 5 days to 15 days, 5 days to 10 days, 10 days to 30 days, 15 days to 30 days, 20 days to 30 days, or 25 days to 30 days.

In some embodiments, the etchant composition comprises less oxidation by-products of the amine-containing compound than a control etchant composition where the control etchant composition is same as the etchant composition but does not comprise a light absorbing compound, a decolorizing agent, or a combination thereof. In some embodiments, the etchant composition comprises 10% less, 15% less, 20% less, 25% less, 30% less, 35% less, 40% less, 45% less, 50% less, 55% less, 60% less, 65% less, 70% less, 75% less, 80% less, 85% less, 90% less, 95% less, 100% less, or greater than 100% less oxidation by-products than a control etchant composition where the control etchant composition is same as the etchant composition but does not comprise a light absorbing compound, a decolorizing agent, or a combination thereof.

Some embodiments related to a method for producing a colorless etchant composition.

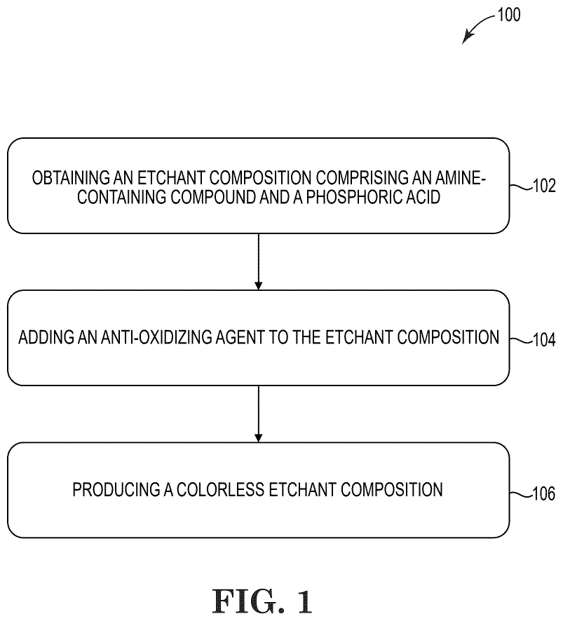

FIG. 1 is a flowchart of the method 100 for producing a colorless etchant composition.

At step 102, in some embodiments, the method comprises obtaining an etchant composition comprising an amine-containing compound and a phosphoric acid. In some embodiments, the etchant composition is used in wet etching processes. In some embodiments, the etchant composition comprises an aqueous solution. In some embodiments, the etchant composition is particle-free.

In some embodiments, the amine-containing compound comprises a primary amine, a secondary amine, a tertiary amine, or a quaternary amine. In some embodiments, the amine-containing compound comprises an alkyl amine, a dialkylamine, or a trialkyl amine. In some embodiments, amine-containing compound comprises at least one of methyl amine, dimethylamine, ethylamine, diethylamine, isopropylamine, di-isopropylamine, butylamine, sec-butylamine, tert-butylamine, di-sec-butylamine, isobutylamine, diisobutylamine, di-tert-pentylamine, ethylmethylamine, isopropyl-n-propylamine, or any combination thereof. Examples of the alkylamines may include, without limitation, one or more of the following: primary alkylamines, such as, for example and without limitation, methylamine, ethylamine, n-propylamine, isopropylamine, n-butylamine, sec-butylamine, isobutylamine, t-butylamine, pentylamine, 2-aminopentane, 3-aminopentane, 1-amino-2-methylbutane, 2-amino-2-methylbutane, 3-amino-2-methylbutane, 4-amino-2-methylbutane, hexylamine, 5-amino-2-methylpentane, heptylamine, octylamine, nonylamine, decylamine, undecylamine, dodecylamine, tridecylamine, tetradecylamine, pentadecylamine, hexadecylamine, heptadecylamine, and octadecylamine; secondary alkylamines, such as, for example and without limitation, dimethylamine, diethylamine, dipropylamine, diisopropylamine, dibutylamine, diisobutylamine, di-sec-butylamine, di-t-butylamine, dipentylamine, dihexylamine, diheptylamine, dioctylamine, dinonylamine, didecylamine, methylethylamine, methylpropylamine, methylisopropylamine, methylbutylamine, methylisobutylamine, methyl-sec-butylamine, methyl-t-butylamine, methylamylamine, methylisoamylamine, ethylpropylamine, ethylisopropylamine, ethylbutylamine, ethylisobutylamine, ethyl-sec-butylamine, ethylamine, ethylisoamylamine, propylbutylamine, and propylisobutylamine; and tertiary alkylamines, such as, for example and without limitation, trimethylamine, triethylamine, tripropylamine, tributylamine, tripentylamine, dimethylethylamine, methyldiethylamine, and methyldipropylamine. Examples of polyamines may include, without limitation, one or more of the following: ethylenediamine, propylenediamine, trimethylenediamine, tetramethylenediamine, 1,3-diaminobutane, 2,3-diaminobutane, pentamethylenediamine, 2,4-diaminopentane, hexamethylenediamine, heptamethylenediamine, octamethylenediamine, nonamethylenediamine, N-methylethylenediamine, N,N-dimethylethylenediamine, trimethylethylenediamine, N-ethylethylenediamine, N,N-diethylethylenediamine, triethylethylenediamine, 1,2,3-triaminopropane, hydrazine, tris(2-aminoethyl) amine, tetra(aminomethyl) methane, diethylenetriamine, triethylenetetramine, tetraethylpentamine, heptaethyleneoctamine, nonaethylenedecamine, and diazabicyloundecene.

In some embodiments, the amine-containing compound comprises an aminosilane. In some embodiments, the aminosilane comprises primary aminosilanes, secondary aminosilanes, tertiary aminosilanes, quaternary aminosilanes, or multi-podal (e.g., dipodal) aminosilanes. In some embodiments, the aminosilane comprises a 3-aminopropylmethyl diethoxysilane, a N-(3-triethoxysilylpropyl)-4,5-dihydroimidazole, a N-(6-aminohexyl) aminomethyl triethoxysilane, a N-(2-aminoethyl)-3-aminoisobutylmethyl dimethoxysilane, a N-(2-aminoethyl)-3-aminopropylmethyl dimethoxysilane, a (N,N-diethylaminomethyl) triethoxysilane, a N-methylaminopropyl trimethoxysilane, an aminoethylaminopropylsilsesquioxane, or any combination thereof.

At step 104, in some embodiments, the method comprises adding a decolorizing agent to the etchant composition. In some embodiments, the decolorizing agent comprises a lanthanide compound in its highest oxidation state. In some embodiments, the lanthanide compound comprises a lanthanide metal cation in its highest oxidation state or a lanthanide metal oxide in its highest oxidation state. In some embodiments, the lanthanide compound has strong scavenging properties of reactive oxygen species or organic radicals formed during thermally or photochemically induced amine oxidation.

In some embodiments, the lanthanide compound comprises a lanthanide metal cation or a lanthanide metal oxide in its highest oxidation state. In some embodiments, the lanthanide compound comprises a cerium compound, a praseodymium compound, a neodymium compound, a terbium compound, a dysprosium compound, a lanthanum compound, an europium compound, or any combination thereof. In some embodiments, the lanthanide compound comprises a salt or oxide of cerium (IV), europium (III), lanthanum (III), or any combination thereof.

At step 106, in some embodiments, the method comprises producing a colorless etchant composition. In some embodiments, the colorless etchant composition comprises a reaction product o the phosphoric acid compound and the decolorizing agent.

In some embodiments, the etchant composition is colorless as determined by having an APHA color of 100 or less. In some embodiments, the etchant composition has an APHA color of 100 or less. In some embodiments, the etchant composition has an APHA color of 90 or less, 80 or less, 70 or less, 60 or less, 50 or less, 40 or less, 30 or less, 20 or less, 10 or less, 5 or less, or 1 or less. In some embodiments, the etchant composition has an APHA color of 0 to 100, or any range or subrange between 0 to 100. In some embodiments, the etchant composition has an APHA color of 0 to 90, 0 to 80, 0 to 70, 0 to 60, 0 to 50, 0 to 40, 0 to 30, 0 to 20, 0 to 10, 0 to 5, 0 to 1, 1 to 100, 5 to 100, 10 to 100, 20 to 100, 30 to 100, 40 to 100, 50 to 100, 60 to 100, 70 to 100, 80 to 100, or 90 to 100.

In some embodiments, the turbidity of the colorless etchant composition is 1 NTU or less. In some embodiments, the turbidity of the colorless etchant composition is 0.9 NTU or less, 0.8 NTU or less, 0.7 NTU or less, 0.6 NTU or less, 0.5 NTU or less, 0.4 NTU or less, 0.3 NTU or less, 0.2 NTU or less, or 0.1 NTU or less. In some embodiments, the turbidity of the colorless etchant composition is 0 to 1 NTU, or any range or subrange between 0 to 1 NTU. In some embodiments, the turbidity of the colorless etchant composition is 0 to 0.9 NTU, 0 to 0.8 NTU, 0 to 0.7 NTU, 0 to 0.6 NTU, 0 to 0.5 NTU, 0 to 0.4 NTU, 0 to 0.3 NTU, 0 to 0.2 NTU, 0 to 0.1 NTU, 0.1 to 1 NTU, 0.2 to 1 NTU, 0.3 to 1 NTU, 0.4 to 1 NTU, 0.5 to 1 NTU, 0.6 to 1 NTU, 0.7 to 1 NTU, 0.8 to 1 NTU, or 0.9 to 1 NTU.

In some embodiments, after aging at 160° C., the colorless etchant composition remains colorless. In some embodiments, after aging at 160° C., the etchant composition continues to have an APHA color of 100 or less. In some embodiments, after aging at 160° C., the etchant composition continues to have an APHA color of 90 or less, 80 or less, 70 or less, 60 or less, 50 or less, 40 or less, 30 or less, 20 or less, 10 or less, 5 or less, or 1 or less. In some embodiments, after aging at 160° C., the etchant composition continues to have an APHA color of 0 to 100, or any range or subrange between 0 to 100. In some embodiments, after aging at 160° C., the etchant composition continues to have an APHA color of 0 to 90, 0 to 80, 0 to 70, 0 to 60, 0 to 50, 0 to 40, 0 to 30, 0 to 20, 0 to 10, 0 to 5, 0 to 1, 1 to 100, 5 to 100, 10 to 100, 20 to 100, 30 to 100, 40 to 100, 50 to 100, 60 to 100, 70 to 100, 80 to 100, or 90 to 100.

In some embodiments, the aging occurs at 160° C. for up to 30 days. In some embodiments, the aging occurs at 160° C. for 5 days to 30 days, or any range or subrange between 5 days to 30 days. In some embodiments, the aging occurs at 160° C. for 5 days to 25 days, 5 days to 20 days, 5 days to 15 days, 5 days to 10 days, 10 days to 30 days, 15 days to 30 days, 20 days to 30 days, or 25 days to 30 days.

Some embodiments relate to a method for producing a colorless composition.

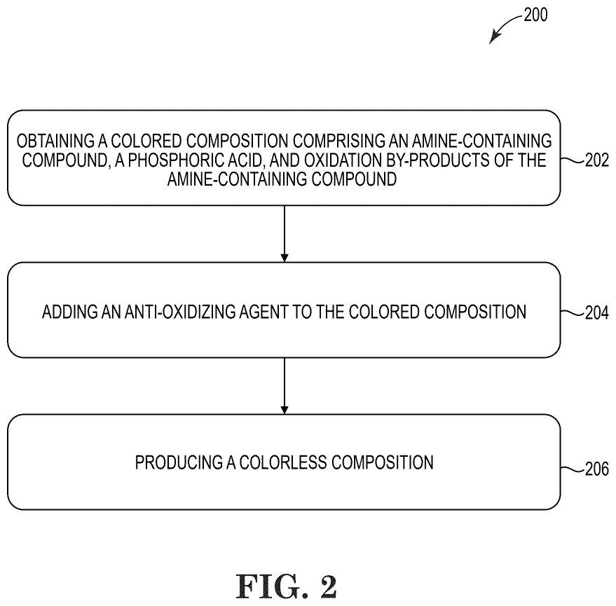

FIG. 2 is a flowchart of the method 200 for producing a colorless etchant composition.

At step 202, in some embodiments, the method comprises obtaining a colored composition. In some embodiments, the colored composition is an aqueous solution. In some embodiments, the colored composition is colored as determined by having an APHA color of greater than 100. In some embodiments, the colored composition has an APHA color of 125 or greater, 150 or greater, 175 or greater, 200 or greater, 225 or greater, 250 or greater, 275 or greater, 300 or greater, 325 or greater, 350 or greater, 375 or greater, 400 or greater, 425 or greater, 450 or greater, or 475 or greater. In some embodiments, the colored composition has an APHA color of greater than 100 to 500, or any range or subrange between greater than 100 to 500. In some embodiments, the colored composition has an APHA color of greater than 100 to 475, greater than 100 to 450, greater than 100 to 425, greater than 100 to 400, greater than 100 to 375, greater than 100 to 350, greater than 100 to 325, greater than 100 to 300, greater than 100 to 275, greater than 100 to 250, greater than 100 to 225, greater than 100 to 200, greater than 100 to 175, greater than 100 to 150, greater than 100 to 125, 125 to 500, 150 to 500, 175 to 500, 200 to 500, 225 to 500, 250 to 500, 275 to 500, 300 to 500, 325 to 500, 350 to 500, 375 to 500, 400 to 500, 425 to 500, 450 to 500, or 475 to 500.

In some embodiments, the colored composition comprises a phosphoric acid. In some embodiments, the phosphoric acid is provided in an aqueous phosphoric acid solution. In some embodiments, the aqueous phosphoric acid solution comprises 50% to 99% by weight of phosphoric acid based on a total weight of the aqueous phosphoric acid solution, or any range or subrange therebetween. In some embodiments, the aqueous phosphoric acid solution comprises 80% to 90% by weight of phosphoric acid based on a total weight of the aqueous phosphoric acid solution. In some embodiments, the aqueous phosphoric acid solution comprises 80% to 85% by weight of phosphoric acid based on a total weight of the aqueous phosphoric acid solution.

In some embodiments, the colored composition comprises an amine-containing compound.

In some embodiments, the amine-containing compound comprises a primary amine, a secondary amine, a tertiary amine, or a quaternary amine. In some embodiments, the amine-containing compound comprises an alkyl amine, a dialkylamine, or a trialkyl amine. In some embodiments, amine-containing compound comprises at least one of methyl amine, dimethylamine, ethylamine, diethylamine, isopropylamine, di-isopropylamine, butylamine, sec-butylamine, tert-butylamine, di-sec-butylamine, isobutylamine, diisobutylamine, di-tert-pentylamine, ethylmethylamine, isopropyl-n-propylamine, or any combination thereof. Examples of the alkylamines may include, without limitation, one or more of the following: primary alkylamines, such as, for example and without limitation, methylamine, ethylamine, n-propylamine, isopropylamine, n-butylamine, sec-butylamine, isobutylamine, t-butylamine, pentylamine, 2-aminopentane, 3-aminopentane, 1-amino-2-methylbutane, 2-amino-2-methylbutane, 3-amino-2-methylbutane, 4-amino-2-methylbutane, hexylamine, 5-amino-2-methylpentane, heptylamine, octylamine, nonylamine, decylamine, undecylamine, dodecylamine, tridecylamine, tetradecylamine, pentadecylamine, hexadecylamine, heptadecylamine, and octadecylamine; secondary alkylamines, such as, for example and without limitation, dimethylamine, diethylamine, dipropylamine, diisopropylamine, dibutylamine, diisobutylamine, di-sec-butylamine, di-t-butylamine, dipentylamine, dihexylamine, diheptylamine, dioctylamine, dinonylamine, didecylamine, methylethylamine, methylpropylamine, methylisopropylamine, methylbutylamine, methylisobutylamine, methyl-sec-butylamine, methyl-t-butylamine, methylamylamine, methylisoamylamine, ethylpropylamine, ethylisopropylamine, ethylbutylamine, ethylisobutylamine, ethyl-sec-butylamine, ethylamine, ethylisoamylamine, propylbutylamine, and propylisobutylamine; and tertiary alkylamines, such as, for example and without limitation, trimethylamine, triethylamine, tripropylamine, tributylamine, tripentylamine, dimethylethylamine, methyldiethylamine, and methyldipropylamine. Examples of polyamines may include, without limitation, one or more of the following: ethylenediamine, propylenediamine, trimethylenediamine, tetramethylenediamine, 1,3-diaminobutane, 2,3-diaminobutane, pentamethylenediamine, 2,4-diaminopentane, hexamethylenediamine, heptamethylenediamine, octamethylenediamine, nonamethylenediamine, N-methylethylenediamine, N,N-dimethylethylenediamine, trimethylethylenediamine, N-ethylethylenediamine, N,N-diethylethylenediamine, triethylethylenediamine, 1,2,3-triaminopropane, hydrazine, tris(2-aminoethyl) amine, tetra(aminomethyl) methane, diethylenetriamine, triethylenetetramine, tetraethylpentamine, heptaethyleneoctamine, nonaethylenedecamine, and diazabicyloundecene.

In some embodiments, the amine-containing compound comprises an aminosilane. In some embodiments, the aminosilane comprises primary aminosilanes, secondary aminosilanes, tertiary aminosilanes, quaternary aminosilanes, or multi-podal (e.g., dipodal) aminosilanes. In some embodiments, the aminosilane comprises a 3-aminopropylmethyl diethoxysilane, a N-(3-triethoxysilylpropyl)-4,5-dihydroimidazole, a N-(6-aminohexyl) aminomethyl triethoxysilane, a N-(2-aminoethyl)-3-aminoisobutylmethyl dimethoxysilane, a N-(2-aminoethyl)-3-aminopropylmethyl dimethoxysilane, a (N,N-diethylaminomethyl) triethoxysilane, a N-methylaminopropyl trimethoxysilane, an aminoethylaminopropylsilsesquioxane, or any combination thereof.

In some embodiments, the colored composition comprises oxidation by-products of the amine-containing compound. In some embodiments, the oxidation by-products of the amine-containing compound are formed by thermal oxidation, photochemical oxidation, or a combination thereof of the amine-containing compound.

At step 204, in some embodiments, the method comprises adding a decolorizing agent to the colored composition. In some embodiments, the decolorizing agent comprises a lanthanide compound in its highest oxidation state. In some embodiments, the lanthanide compound comprises a lanthanide metal cation in its highest oxidation state or a lanthanide metal oxide in its highest oxidation state. In some embodiments, the lanthanide compound has strong scavenging properties of reactive oxygen species or organic radicals formed during thermally or photochemically induced amine oxidation.

In some embodiments, the lanthanide compound comprises a lanthanide metal cation or a lanthanide metal oxide in its highest oxidation state. In some embodiments, the lanthanide compound comprises a cerium compound, a praseodymium compound, a neodymium compound, a terbium compound, a dysprosium compound, a lanthanum compound, an europium compound, or any combination thereof. In some embodiments, the lanthanide compound comprises a salt or oxide of cerium (IV), europium (III), lanthanum (III), or any combination thereof.

In some embodiments, the decolorizing agent complexes the oxidation by-products. In some embodiments, the decolorizing agent reacts with the oxidation by-products. In some embodiments, the decolorizing agent reacts with the phosphoric acid to form a light absorbing compound. In some embodiments, the light absorbing compound complexes the oxidation by-products. In some embodiments, the light absorbing compound reacts with the oxidation by-products.

At step 206, in some embodiments, the method comprises producing a colorless composition. In some embodiments, the etchant composition is colorless as determined by having an APHA color of 100 or less. In some embodiments, the etchant composition has an APHA color of 100 or less. In some embodiments, the etchant composition has an APHA color of 90 or less, 80 or less, 70 or less, 60 or less, 50 or less, 40 or less, 30 or less, 20 or less, 10 or less, 5 or less, or 1 or less. In some embodiments, the etchant composition has an APHA color of 0 to 100, or any range or subrange between 0 to 100. In some embodiments, the etchant composition has an APHA color of 0 to 90, 0 to 80, 0 to 70, 0 to 60, 0 to 50, 0 to 40, 0 to 30, 0 to 20, 0 to 10, 0 to 5, 0 to 1, 1 to 100, 5 to 100, 10 to 100, 20 to 100, 30 to 100, 40 to 100, 50 to 100, 60 to 100, 70 to 100, 80 to 100, or 90 to 100.

In some embodiments, the composition is rendered colorless by the decolorizing agent complexing with the oxidation by-products, the decolorizing agent reacting with the oxidation by-products, the light absorbing compound complexing with the oxidation by-products, the light absorbing compound reacting with the oxidation by-products, or any combination thereof.

In some embodiments, a turbidity of the colorless composition is less than the colored composition. In some embodiments, the turbidity of the colorless composition is less than the colored composition by at least 30 NTU, at least 25 NTU, at least 20 NTU, at least 15 NTU, at least 10 NTU, at least 9 NTU, at least 8 NTU, at least 7 NTU, at least 6 NTU, at least 5 NTU, at least 4 NTU, at least 3 NTU, at least 2 NTU, at least 1 NTU, at least 0.9 NTU, at least 0.8 NTU, at least 0.7 NTU, at least 0.6 NTU, at least 0.5 NTU, at least 0.4 NTU, at least 0.3 NTU, at least 0.2 NTU, or at least 0.1 NTU.

In some embodiments, after aging at 160° C., the colorless composition remains colorless. In some embodiments, after aging at 160° C., the etchant composition continues to have an APHA color of 100 or less. In some embodiments, after aging at 160° C., the etchant composition continues to have an APHA color of 90 or less, 80 or less, 70 or less, 60 or less, 50 or less, 40 or less, 30 or less, 20 or less, 10 or less, 5 or less, or 1 or less. In some embodiments, after aging at 160° C., the etchant composition continues to have an APHA color of 0 to 100, or any range or subrange between 0 to 100. In some embodiments, after aging at 160° C., the etchant composition continues to have an APHA color of 0 to 90, 0 to 80, 0 to 70, 0 to 60, 0 to 50, 0 to 40, 0 to 30, 0 to 20, 0 to 10, 0 to 5, 0 to 1, 1 to 100, 5 to 100, 10 to 100, 20 to 100, 30 to 100, 40 to 100, 50 to 100, 60 to 100, 70 to 100, 80 to 100, or 90 to 100.

In some embodiments, the aging occurs at 160° C. for up to 30 days. In some embodiments, the aging occurs at 160° C. for 5 days to 30 days, or any range or subrange between 5 days to 30 days. In some embodiments, the aging occurs at 160° C. for 5 days to 25 days, 5 days to 20 days, 5 days to 15 days, 5 days to 10 days, 10 days to 30 days, 15 days to 30 days, 20 days to 30 days, or 25 days to 30 days.

Some embodiments relate to selectively etching silicon nitride.

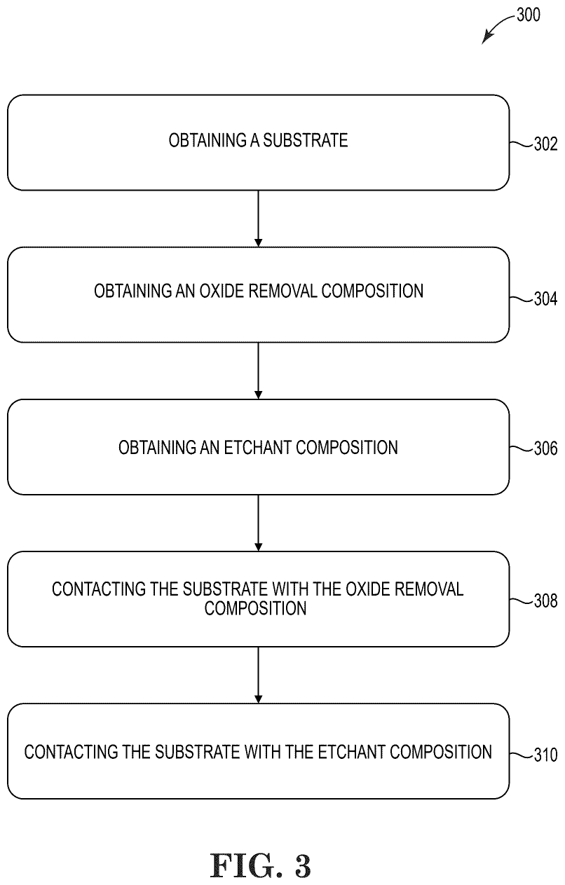

FIG. 3 is a flowchart of a method 100 for selectively etching silicon nitride, according to some embodiments. As shown in FIG. 3, in some embodiments, the methods 300 may comprise at least one of the following steps: a step 302 of obtaining a substrate; a step 304 of obtaining an oxide removal composition; a step 306 of obtaining an etchant composition; a step 308 of contacting the substrate with an oxide removal composition, a step 310 of contacting the substrate with the etchant composition; or any combination thereof.

At step 302, in some embodiments, a substrate is obtained. The substrate may comprise at least one of silicon nitride, silicon oxide, polysilicon, or any combination thereof. In some embodiments, the substrate comprises a surface comprising silicon nitride. In some embodiments, the substrate comprises a surface comprising silicon oxide. In some embodiments, the substrate comprises a surface comprising polysilicon. The substrate may comprise other materials, including surfaces comprising other materials. The substrate can contain other materials that are useful in a microelectronic device, such as one or more of an insulating material, barrier layer, conducting material, semiconducting material, a metal silicide, or a material that is useful for processing a microelectronic device (e.g., photoresist, mask, among others). Examples of substrates include those having a surface that includes at least one of silicon nitride, thermal oxide (ThOx), PETEOS (oxide deposited using plasma enhanced tetraethyl ortho silicate), polysilicon, or any combination thereof.

In some embodiments, the substrate comprises alternating thin film layers of silicon nitride. In some embodiments, the substrate comprises layers of silicon nitride layers alternating with at least one of layers of silicon oxide, layers of polysilicon, layers of conductive metal silicides, layers of dielectrics (e.g., such as zirconium oxide or aluminum oxide), or any combination thereof. Prior to the contacting with the etchant composition, the substrate comprises the alternating layers of silicon nitride positioned in openings between high aspect ratio silicon oxide structures.

At step 304, in some embodiments, an oxide removal composition is obtained. The oxide removal composition may comprise hydrogen fluoride (HF). In some embodiments, the hydrogen fluoride is present in a dilute hydrogen fluoride solution.

At step 306, in some embodiments, an etchant composition is obtained. Any of the colorless etchant compositions disclosed herein may be used.

At step 308, in some embodiments, the substrate is contacted with the oxide removal composition. The oxide removal composition may be useful for removing surface oxides from the substrate and in particular from the silicon nitride surface. That is, in some embodiments, a thin oxidized surface is present on a silicon nitride surface or film. The presence of surface oxides may reduce a rate of etching of the silicon nitride. Accordingly, in some embodiments, the substrate is contacted with the oxide removal composition. As mentioned above, in some embodiments, the oxide removal composition comprises hydrogen fluoride. In some embodiments, the oxide removal composition comprises dilute hydrogen fluoride. After contacting the substrate with the oxide removal composition, excess oxide removal composition and other substances may be rinsed, washed, or otherwise removed from the surfaces using water (e.g., deionized water) at a temperature in a range of 20° C. to 90° C., or any range or subrange therebetween, followed by drying (e.g., spin drying, contacting with nitrogen (N₂), air drying, etc.).

At step 310, in some embodiments, the substrate is contacted with the etchant composition. The contacting may comprise applying the etchant composition to the surface by at least one of spraying the etchant composition onto the surface; dipping (in a static or dynamic volume of the etchant composition) the substrate into etchant composition; contacting the surface with another material (e.g., a pad, or fibrous sorbent applicator element, that has etchant composition absorbed thereon); contacting the substrate with an amount of the etchant composition in a circulating pool; submersing the substrate in the etchant composition; or any combination thereof, among other techniques in which the etchant composition is brought into removal contact with the surface of the microelectronic substrate that contains silicon. The application may be in a batch or single wafer apparatus, for dynamic or static cleaning.

The selective etching of silicon nitride using the etchant composition may proceed in the presence of silicon oxide and polysilicon, as mentioned above. In addition to silicon oxide and polysilicon, the selective etching of silicon nitride using the etchant composition may proceed in the presence of other materials, while maintaining selectivity for silicon nitride. Examples of these other materials include, without limitation, at least one of conductive materials, semiconducting materials, insulating materials, processing materials, or any combination thereof. In some embodiments, a metal silicide is present during the selective etching of silicon nitride. In some embodiments, the metal silicide is present but not exposed during the selective etching of silicon nitride.

The conditions of the contacting may comprise at least one of a duration, a temperature, or any combination thereof. The duration should be sufficient to selectively remove the silicon nitride. The duration of exposure to the etchant composition and the temperature of the etchant composition may be selected based on a desired amount of removal of the silicon nitride from a surface of the substrate. The duration of the contacting should balance process control and quality with process efficiency and throughput of the etching process and the semiconductor fabrication line. Examples of a suitable duration may be in a range of 5 minutes to 300 minutes, or any range or subrange therebetween, such as, 10 minutes to 60 minutes. Examples of a suitable temperature is a temperature in a range of 100° C. to 250° C. (e.g., 100° C. to 180° C., 150° C. to 180° C.), or any range or subrange therebetween. Such contacting times and temperatures are illustrative, and other suitable contacting times and temperature conditions may be used herein without departing from this disclosure.

By contacting the substrate with the etchant composition, the etchant composition may passivate at least one of a surface comprising polysilicon, a surface comprising silicon oxide, or any combination thereof. In some embodiments, passivating a surface comprises modifying the surface so as to reduce a reactivity of the surface—for example, when in the presence of substances that etch silicon nitride. In some embodiments, the metal oxidizer, when in a presence of a surface comprising polysilicon, modifies or is configured to modify the surface comprising polysilicon, so as to reduce a reactivity of the surface comprising polysilicon. In some embodiments, the metal oxidizer, when in a presence of a surface comprising silicon oxide, modifies or is configured to modify the surface comprising silicon oxide, so as to reduce a reactivity of the surface comprising silicon oxide. In some embodiments, the etchant composition passivates surfaces other than silicon nitride.

The etchant composition may exhibit a selectivity for silicon nitride relative to polysilicon of at least 150, at least 200, at least 500, at least 1000, at least 2000, at least 4000, or greater. In some embodiments, for example, the etchant composition exhibits a selectivity for silicon nitride relative to polysilicon of 10:1 to 7000:1, or any range or subrange therebetween. The etchant composition may exhibit a selectivity for silicon nitride relative to silicon oxide of at least 150, at least 200, at least 500, at least 1000, at least 2000, at least 4000, or greater. In some embodiments, for example, the etchant composition exhibits a selectivity for silicon nitride relative to silicon oxide of 10:1 to 7000:1, or any range or subrange therebetween. In some embodiments, the etchant composition's selectivity for silicon nitride relative to polysilicon and silicon oxide is the same or similar. In some embodiments, the etchant composition's selectivity for silicon nitride relative to polysilicon and silicon oxide is different.

After contacting the substrate with the etchant composition, excess etchant composition and other substances may be rinsed, washed, or otherwise removed from the surfaces using water (e.g., deionized water) at a temperature in a range of 20° C. to 90° C., or any range or subrange therebetween, followed by drying (e.g., spin drying, contacting with nitrogen (N₂), air drying, etc.).

Any one or more of the embodiments disclosed herein shall be understood to be combinable without departing from the scope or spirit of the disclosure.

### Example 1

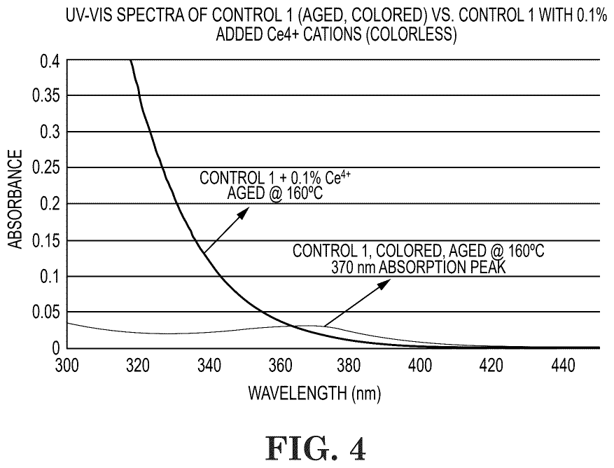

Control 1 is an etchant composition comprising a phosphoric acid compound and an amine-containing compound. Control 1 does not comprise a decolorizing agent nor a light absorbing compound. Control 1 has been aged at 160° C. and is colored as determined by having an APHA color of greater than 100 to 500. 0.1% of Ce⁴⁺ cations (decolorizing agent) were added to Control 1 to obtain etchant composition Formulation 3 (Control 1+0.1% Ce⁴⁺), which is a colorless etchant composition as determined by having an APHA color of 100 or less. Both etchant compositions (Control 1 and Control 1+0.1% Ce⁴⁺) were analyzed using UV-VIS spectroscopy. FIG. 4 shows an overlay of the UV-VIS spectra of Control 1 vs. Control 1+0.1% Ce⁴⁺. As shown in FIG. 4, Control 1 exhibits an absorption peak at 370 nm corresponding to the amine oxidation by-products, whereas Control 1+0.1% Ce⁴⁺ does not exhibit an absorption peak at 370 nm (no oxidation products).

### Example 2

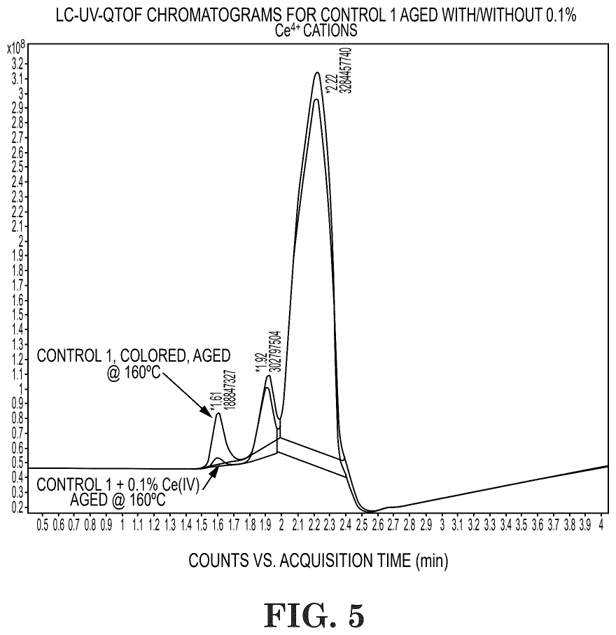

Control 1 is an etchant composition comprising a phosphoric acid compound and an amine-containing compound. Control 1 does not comprise a decolorizing agent nor a light absorbing compound. Control 1 has been aged at 160° C. and is colored as determined by having an APHA color of greater than 100 to 500. 0.1% of Ce⁴⁺ cations (decolorizing agent) were added to Control 1 to obtain etchant composition Formulation 3 (Control 1+0.1% Ce⁴⁺), which is a colorless aged etchant composition as determined by having an APHA color of 100 or less. Both etchant compositions (Control 1 and Control 1+0.1% Ce⁴⁺) were analyzed using LC-UV-QTOF chromatography. FIG. 5 shows an overlay of the LC-UV-QTOF Chromatograms of Control 1 vs. Control 1+0.1% Ce⁴⁺. As shown in FIG. 5, Control 1 has a peak eluted at 1.61 min, which corresponds to the oxidated amine by-product that contributes to the color of the aged composition whereas, Control 1+0.1% Ce⁴⁺, which is colorless, has the same peak of much less intensity (100×) meaning a trace amount of the coloring compound is present.

### Example 3

Control 1 is an etchant composition comprising a phosphoric acid compound and an amine-containing compound. Control 1 does not comprise a decolorizing agent nor a light absorbing compound. The APHA color and turbidity of Control 1 were measured fresh and reported as Formulation 1. Control 1 was aged at 160° C. for 3 weeks with various amounts of different additives added to the composition and the APHA color and turbidity were again measured and reported as Formulations 2-11. Table 1 summarizes the various formulations and additives and the resulting APHA color and turbidity of those formulations.

TABLE 1

| | | APHA | Turbidity |
|---|---|---|---|
| Formulation | % Additive | (PCU) | (NTU) |
| 1 | 0 | 0 | 0.315-0.5 |
| 2 | 0 | 226 | 0.876-0.950 |
| 3 | Ce(IV)(SO₄)₂ (0.1%) | 0 | 0.067-0.078 |
| 4 | Ce(IV) oxide (0.1%) | 0 | 0.088-0.1 |
| 5 | La(III)₂(SO₄)₃ (0.05%) | 48 | 0.27-0.35 |
| 6 | Eu(III)₂(SO₄)₃•8H₂O(0.1%) | 96 | 0.7-0.8 |
| 7 | Y(III) oxide (0.1%) | 205 | 0.89-1.2 |
| 8 | Ce(III)₂(SO₄)₃ (0.1%) | 250 | 1.27 |
| 9 | Ti(IV) oxide (0.1%) | 212 | 1.35 |
| 10 | Zr(IV) oxide (0.1%) | 193 | 0.95-1.51 |
| 11 | Al(III) oxide (0.1%) | 220 | 1.93 |

As can be seen from Table 1, adding a lanthanide compound in its highest oxidation state to the etchant composition results in aged colorless composition (Formulations 3-6) whereas the aged etchant composition that don't have an additive (Formulation 2), that have a non-lanthanide additive (Formulations 7 and 9-11), or that have a lanthanide additive not in its highest oxidation state (Formulation 8) result in colored compositions. Additionally, aged etchant compositions that have a lanthanide compound in its highest oxidation state (Formulations 3-6) have turbidities that are lower than aged etchant compositions that don't have a lanthanide compound in its highest state (Formulations 2 and 7-11). Furthermore, aged etchant compositions comprising Ce(IV) or La(III) (Formulations 3-5) have turbidities (0.067-0.35) that are even lower than the fresh etchant composition (Formulation 1, 0.315-0.5).

### Example 4

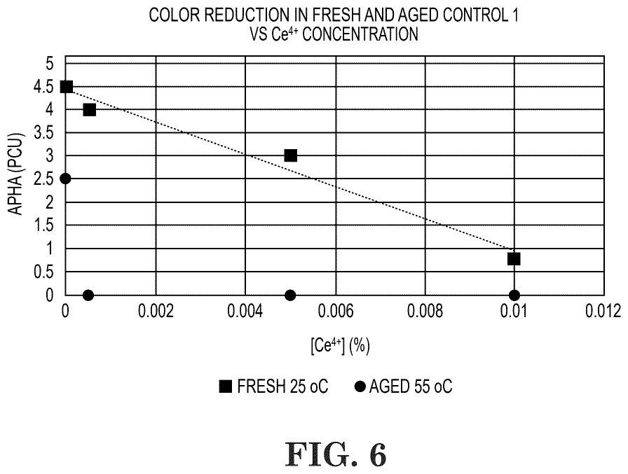

Control 1 is an etchant composition comprising a phosphoric acid compound and an amine-containing compound. Control 1 does not comprise a decolorizing agent nor a light absorbing compound. The APHA color of Control 1 was measured fresh at 25° C. and after aging at 55° C. Ce⁴⁺ cations were added to Control 1 in various amounts and the APHA color of the compositions were measured fresh at 25° C. and after aging at 55° C. FIG. 6 shows the color reduction in the fresh and aged formulations as the percentage of Ce⁴⁺ cations included increases.

### Example 5

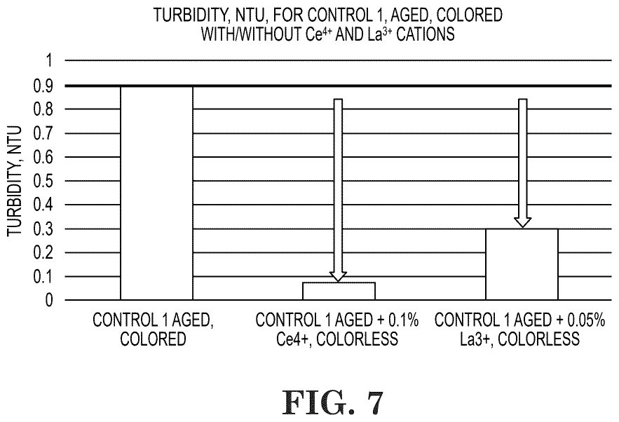

Control 1 is an etchant composition comprising a phosphoric acid compound and an amine-containing compound. Control 1 does not comprise a decolorizing agent nor a light absorbing compound. Control 1 was aged at 160° C. and became colored. The turbidity of the aged composition was measured. 0.1% of Ce⁴⁺ cations was added to an aged Control 1 (Formulation 3), and the composition became colorless. The turbidity of the aged Control 1+Ce⁴⁺ was measured. 0.05% of La³⁺ cations was added to an aged Control 1 (Formulation 4), and the composition became colorless. The turbidity of the aged Control 1+La³⁺ was measured. The turbidity of the three compositions is shown in FIG. 7. As shown in FIG. 7, by adding Ce⁴⁺ cations or La³⁺ cations, the turbidity of the aged etchant composition decreases.

### ASPECTS

Various Aspects are described below. It is to be understood that any one or more of the features recited in the following Aspect(s) can be combined with any one or more other Aspect(s).
Aspect 1. An etchant composition comprising:
   an amine-containing compound;
   a phosphoric acid compound; and
   a light absorbing compound,
      wherein the light absorbing compound comprises a reaction production of the phosphoric acid compound and a decolorizing agent,
         wherein the decolorizing agent comprises a lanthanide compound in its highest oxidation state,
         wherein the lanthanide compound has scavenging properties of reactive oxygen species or organic radicals formed during thermally or photochemically induced amine oxidation; and
   wherein an APHA color value of the etchant composition is less than an APHA color value of a control etchant composition where the control etchant composition is same as the etchant composition but does not comprise a light absorbing compound, a decolorizing agent, or a combination thereof.
Aspect 2. The etchant composition according to Aspect 1, wherein the amine-containing compound comprises an aminosilane.
Aspect 3. The etchant composition according to any one of Aspects 1-2, wherein the lanthanide compound comprises a cerium compound, a praseodymium compound, a neodymium compound, a terbium compound, a dysprosium compound, a lanthanum compound, an europium compound, or any combination thereof.
Aspect 4. The etchant composition according to any one of Aspects 1-3, wherein the lanthanide compound comprises an oxide or salt of cerium (IV), europium (III), lanthanum (III), or any combination thereof.
Aspect 5. The etchant composition according to any one of Aspects 1-4, wherein a turbidity of the etchant composition is 1 NTU or less.
Aspect 6. The etchant composition according to any one of Aspects 1-5, wherein a turbidity of the etchant composition is less than a control etchant composition where the control etchant composition is same as the etchant composition but does not comprise a light absorbing compound, a decolorizing agent, or a combination thereof.
Aspect 7. The etchant composition according to any one of Aspects 1-6, wherein the etchant composition is colorless as determined by having an APHA color of 100 or less.
Aspect 8. The etchant composition according to any one of Aspects 1-7, wherein, after aging at 160° C. for up to 30 days, the etchant composition remains colorless as determined by having an APHA color of 100 or less.
Aspect 9. A method comprising:
   obtaining an etchant composition,
      wherein the etchant composition comprises:
         an amine-containing compound; and
         a phosphoric acid compound;
   adding a decolorizing agent to the etchant composition,
      wherein the decolorizing agent comprises a lanthanide compound in its highest oxidation state,
         wherein the lanthanide compound has scavenging properties of reactive oxygen species or organic radicals formed during thermally or photochemically induced amine oxidation; and
   producing a colorless etchant composition,
      wherein the colorless etchant composition has an APHA color of 100 or less.
Aspect 10. The method according to Aspect 9, wherein the colorless etchant composition comprises a reaction product of the phosphoric acid compound and the decolorizing agent.
Aspect 11. The method according to any one of Aspects 9-10, wherein the amine-containing compound comprises an aminosilane.
Aspect 12. The method according to any one of Aspects 9-11, wherein the lanthanide compound comprises a cerium compound, a praseodymium compound, a neodymium compound, a terbium compound, a dysprosium compound, a lanthanum compound, an europium compound, or any combination thereof.
Aspect 13. The method according to any one of Aspects 9-12, wherein the lanthanide compound comprises an oxide or salt of cerium (IV), europium (III), lanthanum (III), or any combination thereof.
Aspect 14. The method according to any one of Aspects 9-13, wherein a turbidity of the colorless etchant composition is 1 NTU or less.
Aspect 15. The method according to any one of Aspects 9-14, wherein, after aging at 160° C. for up to 30 days, the colorless etchant composition remains colorless as determined by having an APHA color of 100 or less.
Aspect 16. A method comprising:
   obtaining a colored composition having an APHA color of greater than 100,
      wherein the colored composition comprises:
         a phosphoric acid compound;
         an amine-containing compound; and
         oxidation by-products of the amine-containing compound;
   adding a decolorizing agent to the colored composition,
      wherein the decolorizing agent comprises a lanthanide compound in its highest oxidation state,
         wherein the lanthanide compound has scavenging properties of reactive oxygen species or organic radicals formed during thermally or photochemically induced amine oxidation; and
   producing a colorless composition,
      wherein the colorless composition has an APHA color of 100 or less.
Aspect 17. The method according to Aspect 16, wherein the amine-containing compound comprises an aminosilane.
Aspect 18. The method according to any one of Aspects 16-17, wherein the lanthanide compound comprises a cerium compound, a praseodymium compound, a neodymium compound, a terbium compound, a dysprosium compound, a lanthanum compound, an europium compound, or any combination thereof.
Aspect 19. The method according to any one of Aspects 16-18, wherein the decolorizing agent complexes the oxidation by-products.
Aspect 20. The method according to any one of Aspects 16-19, wherein a turbidity of the colorless composition is less than the colored composition.
Aspect 21. An etchant composition comprising:
   an amine-containing compound;
   a phosphoric acid compound; and
   a light absorbing compound,
      wherein the light absorbing compound comprises a reaction production of the phosphoric acid compound and a decolorizing agent,
         wherein the decolorizing agent comprises a lanthanide compound in its highest oxidation state,
         wherein the lanthanide compound has scavenging properties of reactive oxygen species or organic radicals formed during thermally or photochemically induced amine oxidation; and
   wherein the etchant composition comprises less oxidation by-products of the amine-containing compound than a control etchant composition where the control etchant composition is same as the etchant composition but does not comprise a light absorbing compound, a decolorizing agent, or a combination thereof.

What is claimed is:

1. An etchant composition comprising:
an amine-containing compound;
a phosphoric acid compound; and
a light absorbing compound,
wherein the light absorbing compound comprises a reaction production of the phosphoric acid compound and a decolorizing agent,
wherein the decolorizing agent comprises a lanthanide compound in its highest oxidation state,
wherein the lanthanide compound has scavenging properties of reactive oxygen species or organic radicals formed during thermally or photochemically induced amine oxidation; and
wherein an APHA color value of the etchant composition is less than an APHA color value of a control etchant composition where the control etchant composition is same as the etchant composition but does not comprise a light absorbing compound, a decolorizing agent, or a combination thereof.

2. The etchant composition of claim 1, wherein the amine-containing compound comprises an aminosilane.

3. The etchant composition of claim 1, wherein the lanthanide compound comprises a cerium compound, a praseodymium compound, a neodymium compound, a terbium compound, a dysprosium compound, a lanthanum compound, an europium compound, or any combination thereof.

4. The etchant composition of claim 1, wherein the lanthanide compound comprises an oxide or salt of cerium (IV), europium (III), lanthanum (III), or any combination thereof.

5. The etchant composition of claim 1, wherein a turbidity of the etchant composition is 1 NTU or less.

6. The etchant composition of claim 1, wherein a turbidity of the etchant composition is less than a control etchant composition where the control etchant composition is same as the etchant composition but does not comprise a light absorbing compound, a decolorizing agent, or a combination thereof.

7. The etchant composition of claim 1, wherein the etchant composition is colorless as determined by having an APHA color of 100 or less.

8. The etchant composition of claim 7, wherein, after aging at 160° C. for up to 30 days, the etchant composition remains colorless as determined by having an APHA color of 100 or less.

9. A method comprising:
obtaining an etchant composition,
wherein the etchant composition comprises:
an amine-containing compound; and
a phosphoric acid compound;
adding a decolorizing agent to the etchant composition,
wherein the decolorizing agent comprises a lanthanide compound in its highest oxidation state,
wherein the lanthanide compound has scavenging properties of reactive oxygen species or organic radicals formed during thermally or photochemically induced amine oxidation; and
producing a colorless etchant composition,
wherein the colorless etchant composition has an APHA color of 100 or less.

10. The method of claim 9, wherein the colorless etchant composition comprises a reaction product of the phosphoric acid compound and the decolorizing agent.

11. The method of claim 9, wherein the amine-containing compound comprises an aminosilane.

12. The method of claim 9, wherein the lanthanide compound comprises a cerium compound, a praseodymium compound, a neodymium compound, a terbium compound, a dysprosium compound, a lanthanum compound, an europium compound, or any combination thereof.

13. The method of claim 9, wherein the lanthanide compound comprises an oxide or salt of cerium (IV), europium (III), lanthanum (III), or any combination thereof.

14. The method of claim 9, wherein a turbidity of the colorless etchant composition is 1 NTU or less.

15. The method of claim 9, wherein, after aging at 160° C. for up to 30 days, the colorless etchant composition remains colorless as determined by having an APHA color of 100 or less.

16. A method comprising:
obtaining a colored composition having an APHA color of greater than 10,
wherein the colored composition comprises:
a phosphoric acid compound;
an amine-containing compound; and
oxidation by-products of the amine-containing compound;
adding a decolorizing agent to the colored composition,
wherein the decolorizing agent comprises a lanthanide compound in its highest oxidation state,
wherein the lanthanide compound has scavenging properties of reactive oxygen species or organic radicals formed during thermally or photochemically induced amine oxidation; and
producing a colorless composition,
wherein the colorless composition has an APHA color of 100 or less.

17. The method of claim 16, wherein the amine-containing compound comprises an aminosilane.

18. The method of claim 16, wherein the lanthanide compound comprises a cerium compound, a praseodymium compound, a neodymium compound, a terbium compound, a dysprosium compound, a lanthanum compound, an europium compound, or any combination thereof.

19. The method of claim 16, wherein the decolorizing agent complexes the oxidation by-products.

20. The method of claim 16, wherein a turbidity of the colorless composition is less than the colored composition.

21. An etchant composition comprising:
an amine-containing compound;
a phosphoric acid compound; and
a light absorbing compound,
wherein the light absorbing compound comprises a reaction production of the phosphoric acid compound and a decolorizing agent,
wherein the decolorizing agent comprises a lanthanide compound in its highest oxidation state,
wherein the lanthanide compound has scavenging properties of reactive oxygen species or organic radicals formed during thermally or photochemically induced amine oxidation; and
wherein the etchant composition comprises less oxidation by-products of the amine-containing compound than a control etchant composition where the control etchant composition is same as the etchant composition but does not comprise a light absorbing compound, a decolorizing agent, or a combination thereof.
